(19) United States
(12) Patent Application Publication
(10) Pub. No.: US 2026/0131835 A1
(43) Pub. Date: May 14, 2026

(54) Methods and Systems for Multi-Sensor Fusion Railway Vehicle Localization

(71) Applicant: Intramotev Inc., St. Louis, MO (US)

(72) Inventor: Samuel David King, O'Fallon, IL (US)

(21) Appl. No.: 18/943,536

(22) Filed: Nov. 11, 2024

(51) Int. Cl. B61L 25/02; B61L 27/70; G01C 21/00

(52) U.S. Cl. CPC B61L 25/025; B61L 27/70; G01C 21/3848

(57) ABSTRACT

Techniques and systems for multi-sensor fusion railway vehicle localization are presented herein. A computing system initially receives sensor data from sensors coupled to a railway vehicle as the railway vehicle travels along a rail in an environment and determines, based on the sensor data, a three-dimensional (3D) position of the railway vehicle in the environment. The computing system then determines, based on the 3D position of the railway vehicle, a two-dimensional (2D) location of the railway vehicle within a digital map of a track network and provides the 2D location of the railway vehicle within the digital map of the track network to a control system of the railway vehicle. In some cases, a system may generate the digital map of the track networks in the form of a graph network with nodes and segments to convey location data, speed limits, and other useful information for railway vehicle travel.

### FIELD

The present disclosure relates to railway transportation systems, and more particularly to multi-sensor fusion techniques for precise railway vehicle navigation and localization on track networks.

### BACKGROUND

Freight trains and other types of railway vehicles are a common mode of transportation for a wide range of goods and materials. In general, railway vehicles are typically designed to carry heavy loads over long distances, making them a cost-effective and efficient solution for various industries.

Accurate localization and navigation of railcars within complex track networks are fundamental challenges in the railway industry. Precise knowledge of a railcar's position is essential for various aspects of rail operations, including traffic management, collision avoidance, and optimized scheduling. Traditional methods of railcar localization often rely on fixed wayside equipment or simple Global Positioning Systems (GPS) systems, which may have limitations in terms of accuracy, reliability, or coverage.

### SUMMARY

Example embodiments relate techniques and systems for precise railway vehicle localization on a track network using multi-sensor fusion, such as GPS, Inertial Measurement Unit (IMU), and odometer data. A system may use non-linear sensor fusion techniques, such as Kalman filtering, to determine a three-dimensional (3D) position of a railway vehicle, which is then projected onto a two-dimensional (2D) location on the track network using a particle filter and a pre-established track map. The pre-established track map may divide tracks into different segments based on various parameters and may enable the 2D location to accurately convey the position of the railway vehicle relative to defined segments and other points of interest. As such, the 2D location of the railway vehicle within the track network can be used for various purposes in railway operations and management. In some aspects, the 2D location data may be integrated with collision avoidance systems to prevent accidents by detecting potential conflicts with other trains or obstacles on the track. The location information may also be utilized in scheduling and dispatching systems to optimize train routing, manage train consists, manage traffic flow, and improve overall network efficiency. In some cases, the 2D location data may be employed for real-time tracking and monitoring of cargo or passenger trains, enabling accurate arrival time predictions and enhancing customer service. The location information may also be valuable for maintenance planning, which can enable railway operators to precisely locate areas requiring inspection or repair along the track network.

Accordingly, a first example embodiment describes a method. The method involves receiving, at a computing system, sensor data from a plurality of sensors coupled to a railway vehicle as the railway vehicle travels along a rail in an environment and determining, based on the sensor data, a three-dimensional (3D) position of the railway vehicle in the environment. The method also involves determining, by the computing system and based on the 3D position of the railway vehicle, a two-dimensional (2D) location of the railway vehicle within a digital map of a track network comprising the rail and providing the 2D location of the railway vehicle within the digital map of the track network to a control system of the railway vehicle.

Another example embodiment describes a system. The system includes a plurality of sensors coupled to a railway vehicle and a computing system. The computing system is configured to receive sensor data from a plurality of sensors coupled to a railway vehicle as the railway vehicle travels along a rail in an environment and determine, based on the sensor data, a three-dimensional (3D) position of the railway vehicle in the environment. The computing system is also configured to determine, based on the 3D position of the railway vehicle, a two-dimensional (2D) location of the railway vehicle within a digital map of a track network comprising the rail and provide the 2D location of the railway vehicle within the digital map of the track network to a control system of the railway vehicle.

An additional example embodiment describes a non-transitory computer readable medium configured to store instructions, that when executed by a computing system comprising one or more processors, causes the computing system to perform operations. The operations involve receiving sensor data from a plurality of sensors coupled to a railway vehicle as the railway vehicle travels along a rail in an environment and determining, based on the sensor data, a three-dimensional (3D) position of the railway vehicle in the environment. The operations also involve determining, based on the 3D position of the railway vehicle, a two-dimensional (2D) location of the railway vehicle within a digital map of a track network comprising the rail and providing the 2D location of the railway vehicle within the digital map of the track network to a control system of the railway vehicle.

According to other aspects of the present disclosure, the control system may include potential variations. These variations could include different types of control theory, optimization algorithms, and integration with other systems, energy sources, safety features, and user interfaces.

### BRIEF DESCRIPTION OF THE FIGURES

FIG. 1 is a functional block diagram illustrating a motive system for a railway vehicle, according to one or more example embodiments.

FIG. 2 is a functional block diagram illustrating a computing system, according to one or more example embodiments.

FIG. 3 is a configuration of a railway vehicle with a motive system, according to one or more example embodiments.

FIG. 4 is another configuration of a railway vehicle with a motive system, according to one or more example embodiments.

FIG. 5 is an additional configuration of a railway vehicle with a motive system, according to one or more example embodiments.

FIG. 6 is a functional block diagram of a system for performing multi-sensor fusion railway vehicle localization, according to one or more example embodiments.

FIG. 7 is a flowchart of a method for performing multi-sensor fusion railway vehicle localization, according to one or more example embodiments.

### DETAILED DESCRIPTION

In the following detailed description, reference is made to the accompanying figures, which form a part hereof. In the figures, similar symbols typically identify similar components, unless context dictates otherwise. The illustrative embodiments described in the detailed description, figures, and claims are not meant to be limiting. Other embodiments may be utilized, and other changes may be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

The present disclosure relates to advanced methods and systems for precise railway vehicle navigation and localization on track networks. These methods and systems may use a multi-sensor fusion approach that integrates data from a diverse array of sensors to determine a railway vehicle's position with high accuracy and optimize its operation in real-time.

At the core of an example system is a sensor array that may include, but is not limited to, Global Positioning System (GPS) receivers, Inertial Measurement Units (IMUs), high-resolution cameras, millimeter-wave radars, LiDAR (Light Detection and Ranging) sensors, and precision odometers. For example, a freight railcar might be retrofitted with a dual-frequency GPS receiver capable of centimeter-level accuracy, a six-axis IMU measuring acceleration and angular velocity, multiple 4K resolution cameras for visual odometry and obstacle detection, and a 360-degree LiDAR sensor for detailed environmental mapping. The sensors and configuration of railway vehicles can differ within examples.

The sensor data may be processed by one or more high-performance computing systems using advanced non-linear sensor fusion techniques. These may include Extended Kalman Filters (EKF) for handling non-linear motion models, Unscented Kalman Filters (UKF) for highly non-linear systems, or more advanced methods like Particle Filters for non-Gaussian noise distributions. For instance, an onboard computer may use an EKF to fuse GPS position data with IMU acceleration and angular velocity measurements, while simultaneously integrating visual odometry data from the cameras. This fusion process may occur at high frequencies, such as 100 Hz or higher (or in terms of time e.g., 10 milliseconds or less), to ensure real-time performance.

Another component of the system is a high-fidelity digital map of the track network. This map may be represented as a graph structure, where nodes correspond to physical infrastructure elements such as switches, crossings, bridges, tunnels, elevated track, and stations, while edges represent track segments. Each node and edge may be enriched with metadata, such as precise geographical coordinates (latitude, longitude, and elevation), track gauge, maximum allowed speed, gradient, curvature, communication dead zones, and unique identifiers. For example, a switch node might include data on its exact 3D position, the types and directions of tracks it connects, and any speed restrictions associated with each possible path through the switch.

In some examples, the localization process involves a two-step approach. First, the system determines the railway vehicle's three-dimensional (3D) position in the global reference frame using the fused sensor data. This 3D position can then be projected onto the digital map to determine the vehicle's two-dimensional (2D) location within the track network. In some cases, for this 2D localization, the system may use probabilistic techniques such as particle filters or Hidden Markov Models (HMMs). As an example, a particle filter may maintain a set of 1000 particles, each representing a possible vehicle location on the track network. The weights of these particles are updated based on how well they match the observed sensor data and the known track geometry.

In some examples, the system may use a particle filter that combines probabilistic estimation with the various information contained in the digital map to pinpoint the location of the railway vehicle and determine its distance and time from Points of Interest (POIs). This process may begin with particle initialization, where the filter generates a set of particles, typically numbering in the hundreds or thousands, each representing a possible location of the railway vehicle on the track network. Every particle is associated with a specific position on a track segment and carries a weight that represents its probability of being the true location of the vehicle. As the railway vehicle moves, the filter enters the prediction step where it predicts the new position of each particle based on several factors, such as the previous position of the particle, the estimated velocity and heading of the railway vehicle (e.g., derived from IMU and odometer data), and the track geometry information from the digital map, such as curvature and gradient. This step allows the filter to account for the expected movement of the vehicle along the tracks. Following prediction, the filter performs an update step. In this phase, the filter updates the weight of each particle based on how well it matches the observed sensor data and the map metadata. Particles closer to the GPS-reported position receive higher weights, as do particles whose motion aligns with the measured accelerations and angular velocities from the IMU. Additionally, particles whose surrounding track environment (as described in the digital map) better matches the observed visual or LiDAR data are weighted higher. Importantly, particles that violate track constraints, such as those that would place the vehicle off the tracks, have their weights reduced or are eliminated entirely.

After updating the weights, the filter performs a resampling step. Here, particles with low weights are eliminated, and new particles are generated around the high-weight particles. This process focuses the estimation on the most likely locations, improving the accuracy of the filter over time. The final estimated location of the railway vehicle is typically calculated as the weighted average of all particle positions or by selecting the position of the highest-weight particle. Once the vehicle's location on the track network is estimated, the system can calculate the distance to various POIs. It does this by first identifying the current track segment and the upcoming POIs from the digital map. Then, the system calculates the along-track distance to each POI by summing the lengths of track segments between the current position and the POI. Using the current speed of the vehicle and the speed limits stored in the map metadata, the system can also estimate the time required to reach each POI. In some examples, the system may factor additional information, such as infrastructure health, location of other trains, and weather conditions.

As an example, if the particle filter estimates that the train is on track segment A, 200 meters from its start, and the next POI (such as a station) is on segment C, the system would calculate the remaining distance on segment A, add the full length of segment B, and then add the distance from the start of segment C to the station's position. The sum of these distances provides the total distance to the POI. By dividing this distance by the expected average speed, considering speed limits and typical acceleration/deceleration profiles, the system can estimate the time to reach the POI. Weather, track use, infrastructure condition, and other factors may also be considered by the system during estimations. As such, this comprehensive process allows the system to provide accurate, real-time estimates of the vehicle's location and its proximity to important points along its route. The use of particle filtering, combined with detailed digital map data, enables the system to maintain high accuracy even in complex network topologies with multiple parallel tracks or switches, providing crucial information for efficient railway operations and precise scheduling.

In some examples, the system's operational capabilities are extensive and leverage advanced algorithms for route planning, energy optimization, and predictive maintenance. For route planning, the system may use one or multiple search algorithms on the track network graph, considering factors like distance, travel time, energy consumption, and track conditions. Energy optimization could involve model predictive control (MPC) techniques that consider upcoming track geometry, scheduled stops, and real-time traffic conditions to minimize power consumption while meeting timetable constraints.

Safety and reliability are important in the system design. For instance, a system may incorporate redundancy at both hardware and software levels. A system may use a federated Kalman filter architecture where multiple independent filters process data from different sensor subsets, with a master filter combining their outputs. This approach provides robustness against individual sensor failures. The system may also implement real-time integrity monitoring, continuously checking for inconsistencies in sensor data and localization results. In addition, machine learning algorithms, particularly deep learning models, may be integrated to enhance system performance over time. For example, a convolutional neural network (CNN) might be trained on historical camera images to improve landmark recognition for visual localization. Recurrent neural networks (RNNs) could be employed to learn patterns in vehicle dynamics and energy consumption, enabling more accurate predictions. The high-precision 3D position and 2D track location data enable a multitude of advanced applications. These include centimeter-level precision for platform stopping in high-speed rail scenarios, real-time adjustment of pantograph height based on overhead line geometry in electric locomotives, and predictive maintenance through continuous monitoring of track quality using onboard sensor data.

The non-transitory computer readable medium may include any type of medium capable of storing computer-readable instructions, such as a hard drive, solid state drive, flash memory, read-only memory (ROM), random-access memory (RAM), or any other type of non-volatile or volatile memory. In some cases, the non-transitory computer readable medium may be a part of the computing system, while in other cases, it may be a separate device that is accessible to the computing system. The instructions stored on the non-transitory computer readable medium may include machine code, source code, script, or any other type of instructions that can be executed by a computing system. These instructions may be written in any programming language or framework, such as C++, C#, Java, Python, or any other suitable language or framework. The instructions may be compiled or interpreted, depending on the type of computing system and the requirements of the application. The computing system that executes the instructions may include one or more processors, such as a central processing unit (CPU), a graphics processing unit (GPU), a digital signal processor (DSP), or any other type of processor. The computing system may also include other components, such as memory, storage, input/output devices, network interfaces, or any other components that may be needed to perform the operations.

Systems and techniques presented herein can be used for optimizing operations of various types of vehicles, including non-railway vehicles. For instance, systems can optimize operations for trucks, cars, robotic devices, aircraft, drones, construction equipment, farm equipment, trolleys, and other types of vehicles.

The following description and accompanying drawings will elucidate features of various example embodiments. The embodiments provided are by way of example, and are not intended to be limiting. As such, the dimensions of the drawings are not necessarily to scale. Example systems and methods within the scope of the present disclosure will now be described in greater detail.

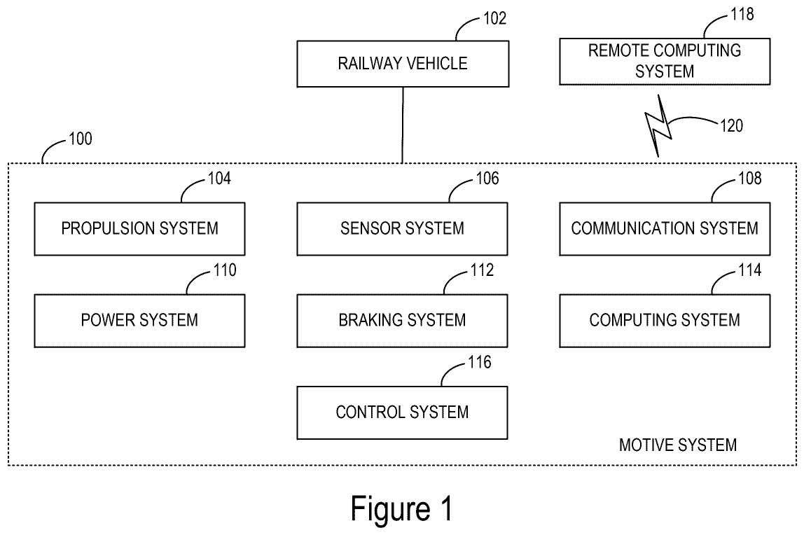

Referring now to the figures, FIG. 1 is a functional block diagram showing motive system 100, which can be implemented on railway vehicle 102 and configured to perform disclosed operations. In the example embodiment, motive system 100 may include various subsystems, such as propulsion system 104, sensor system 106, communication system 108, power system 110, braking system 112, computing system 114, and control system 116. In other examples, motive system 100 may include more or fewer subsystems. In addition, the subsystems and other components of motive system 100 can be interconnected via wired or wireless connections and operations performed by motive system 100 can be divided into additional functional or physical components and/or combined into fewer functional or physical components within examples.

Railway vehicle 102 represents any type of vehicle that can transport people and/or cargo on a railway track. This includes, but is not limited to, freight trains, passenger trains, locomotives, trolleys, and other types of railcars. Railway vehicles are typically designed to transport goods, materials, or passengers over long distances and may be capable of self-propelling functions. For instance, railway vehicle 102 may be powered by various types of energy sources, such as diesel, electricity (e.g., electric motor with a battery system), or alternative fuels. In some cases, railway vehicle 102 is a self-propelled railcar equipped with the disclosed energy-efficient control system.

In some examples, railway vehicle 102 may be a freight car or a flatbed car configured to move materials or other types of materials. For instance, railway vehicle 102 may be a burdened rail vehicle. Traditional locomotives are unburdened (i.e., not carrying payload) whereas traditional freight railcars are unpowered and serve to carry payloads similar to trailers as burdened vehicles. As such, the size, shape, and configuration of railway vehicle 102 can differ within examples. In addition, the number and types of axles and wheels on railway vehicle 102 can vary. Generally, railway vehicle 102 may include two axles per truck with two trucks per railcar. Railway vehicle 102 may include one or multiple types of couplers that enable railway vehicle 102 to be coupled to other railway vehicles.

Propulsion system 104 of motive system 100 may be designed with a variety of components to provide powered motion for railway vehicle 102. For instance, propulsion system 104 could include one or more motors that utilize power from power system 110 to generate torque, thereby rotating the wheels of railway vehicle 102.

In some cases, propulsion system 104 may be designed with different types of motors. For example, propulsion system 104 could use electric motors, hydraulic motors, or pneumatic motors. These different types of motors could provide different benefits, such as improved energy efficiency or increased torque. In addition, propulsion system 104 could use power from different types of power systems. For instance, propulsion system 104 may use power from a battery (or battery system), a fuel cell, a solar panel, and/or a generator. These different types of power systems could provide different benefits, such as improved energy efficiency or increased operational range.

In addition, propulsion system 104 may generate torque in different ways. For example, propulsion system 104 may use a gearbox to increase the torque or a direct drive system to eliminate the gearbox and reduce mechanical losses. These different methods of torque generation could provide different benefits, such as improved efficiency or reduced maintenance requirements. Similarly, propulsion system 104 may also rotate the wheels of railway vehicle 102 in different ways. For example, propulsion system 104 may use a chain drive, a belt drive, or a direct drive system. These different methods of wheel rotation could provide various benefits, such as improved efficiency or reduced noise.

Furthermore, propulsion system 104 could be configured in different ways. For example, propulsion system 104 may be a centralized system with a single motor driving all the wheels, or it could be a distributed system with individual motors driving each wheel. The different configurations could be selected based on the different benefits that each configuration is designed to provide, such as improved traction or increased redundancy.

Sensor system 106 may include one or multiple sensors that can help enhance the performance of railway vehicle 102. In particular, sensor system 106 may be used to gather and process data about the environment in which railway vehicle 102 operates, the performance of the vehicle's components, and to tailor the performance of railway vehicle 102 to suit its environment. In some examples, sensor system 106 may encompass a diverse range of sensors, such as one or more radars, lidars, cameras, wind sensors, force sensors, contact sensors, precipitation sensors, light sensors, humidity sensors, strain gauges, pressure transducers, thermal imaging sensors, radio navigation units, encoders, resolvers, laser range finding sensors, Radio-Frequency Identification (RFID) sensors, gyroscopes and magnetometers, accelerometers, magnetic sensors, microphones, strain and weight sensors, GPS receivers, IMUs, passive infrared sensors, ultrasonic sensors, wheel speed sensors, and/or throttle/brake sensors. Railway vehicle 102 may include one or more of these sensors as well as other types of sensors. As such, a wide array of sensors may allow system 100 to gather a comprehensive set of data about the operation of railway vehicle 102 and its environment, enhancing the control system's ability to determine a control strategy for operating railway vehicle 102.

Sensor system 106 may also include sensors that are specifically configured to monitor the existing components of railway vehicle 102. This could include sensors that monitor the status and performance metrics of the train's engine, brakes, battery system, and other components. In some cases, sensor system 106 may also use multiple sensors to provide safety redundancy, ensuring that motive system 100 can continue to operate safely even if one sensor fails. This redundancy feature enhances the reliability and safety of the control system of railway vehicle 102, ensuring that it can maintain optimum operation even in the event of sensor failures.

The sensors from sensor system 106 can be strategically placed on different components of railway vehicle 102. For instance, some sensors could be positioned on the couplers of railway vehicle 102, while others may be housed in a specific container positioned near the front or rear end of railway vehicle 102. Some sensors could be designed to measure specific aspects of the couplers on railway vehicle 102. For instance, these sensors could provide data on the stress level on the couplers, which could be used to monitor the structural integrity of the couplers and prevent potential failures. In some examples, sensors are positioned on the wheels or axles to monitor their rotation and detect any irregularities. Sensors may also be placed inside the cargo compartments to monitor the condition of the cargo, such as temperature or humidity sensors for perishable goods. Sensors may be installed in pneumatic braking air hoses/pipes to monitor the required pressures. A strategic placement of sensors allows sensor system 106 to gather detailed and accurate data about the operations of railway vehicle 102 and its components.

In some examples, sensor system 106 may include sensors that can detect waypoints positioned along the railway track. The waypoints may provide useful information about the location, direction, and speed of railway vehicle 102, which could be used by the control system to adjust the operations of railway vehicle 102 in real-time. Sensor system 106 may also enable railway vehicle 102 to triangulate its position relative to off-board radio stations and other sources of communication signals, such as 4G or 5G towers. This could provide more accurate and real-time data about the location and speed of railway vehicle 102, enhancing the control system's ability to determine the optimum speeds for railway vehicle 102 as conditions change.

Sensor system 106 can also be used to weigh railway vehicle 102 and adjust the performance of the electric motors and other components located on railway vehicle 102. This could involve sensors that measure the weight of railway vehicle 102 and its cargo, which could be used to adjust speed of railway vehicle 102 and power output to maintain optimum energy efficiency and safety. This weight measurement feature can allow the control system to adapt the operation of railway vehicle 102 to its load, ensuring that motive system 100 can maintain optimum energy efficiency and safety even as the weight of railway vehicle 102 shifts or changes.

In some examples, sensor system 106 can be supplemented by additional devices. These devices could include additional sensors, control systems, or communication devices that enhance the performance and functionality of sensor system 106. This flexibility in the design of sensor system 106 allows it to adapt to different operational requirements and environmental conditions, enhancing its performance and functionality.

In some examples, sensor system 106 may include a motor encoder and/or resolver data, which can be used to detect wheel slipping on railway vehicle 102 due to wet, icy, or debris-laden tracks. In response to this detection, computing system 114 may implement effective control strategies to maintain the traction and safety of railway vehicle 102. Onboard sensors can also be used to detect potential vandalism. For instance, computing system 114 may use cameras and radar to detect potential vandalism and responsively transmit information to a user and/or authorities to protect the cargo and payloads via communication system 108.

In addition, sensor system 106 can be used for automated track inspections and to determine the condition of the rail. In some cases, computing system 114 may determine deviation from normal rail characteristics based on sensor data from sensor system 106. For instance, computing system 114 may detect railcar hunting, vibration, and other dynamics based on sensor data obtained from sensor system 106. This could provide valuable information about the condition of the track and the train's operation, which may be used by computing system 114 to adjust the train's speed and trajectory to maintain optimum energy efficiency and safety.

In some examples, sensor system 106 may also include different types of sensors beyond those mentioned. For instance, sensor system 106 may include pressure sensors to monitor the air pressure in the pneumatic braking system, vibration sensors to detect abnormal vibrations in the components of railway vehicle 102, or acoustic sensors to detect unusual noises that could indicate a mechanical problem. These additional sensors could provide more comprehensive data about the operations of railway vehicle 102 and its environment, further enhancing the control system's ability to determine the optimal speeds for railway vehicle 102.

Sensor system 106 may be integrated with other systems on a train. For example, sensor system 106 may be integrated with communication system 108 to transmit sensor data to a remote control station (e.g., remote computing system 118) or to other trains. Sensor system 106 could also be integrated with power system 110 to draw power for its operation. This integration could enhance the functionality and efficiency of sensor system 106, which allows for more effective and reliable operation.

The sensor data may be processed in different ways to determine control strategy for railway vehicle 102. For example, the data may be processed using machine learning algorithms to learn from past data and make more accurate predictions about speed ranges to use during navigation along certain portions of track. The speed ranges may depend on weather conditions, type and size of load, and/or other parameters (e.g., length of train). Sensor data may also be processed using statistical methods to analyze the data and identify patterns or trends that could be used to optimize the speed and other control parameters of railway vehicle 102.

In some examples, sensor system 106 may include additional layers of redundancy to ensure its reliability and safety. For example, sensor system 106 may include multiple sensors of the same type, so that if one sensor fails, the others can continue to provide data. Sensor system 106 may also include backup power sources for the sensors, ensuring that they can continue to operate even if the main power source fails. In addition, the sensors within sensor system 106 may be calibrated in different ways to ensure their accuracy and reliability. For example, sensors may be calibrated using standard calibration techniques, or they could be self-calibrating, adjusting their calibration based on the data they collect. This could enhance the accuracy and reliability of the sensor data, further improving the control system's ability to determine the optimum speeds for the train.

As further shown in FIG. 1, motive system 100 may include communication system 108, which may be used to communicate with one or more devices (e.g., remote computing system 118) directly or via a communication network (e.g., wireless connection 120). In some examples, communication system 108 may include one or multiple dedicated short-range communications (DSRC) devices that could include public and/or private data communications with stations positioned near tracks.

In general, communication system 108 may facilitate the exchange of information with other devices and between components of railway vehicle 102. The exchange of information could include communication with remote computing system 118, which might be a centralized server or control station that oversees the operation of multiple trains. The communication between the control system of railway vehicle 102 and remote computing system 118 may be facilitated through a communication network, such as a wireless connection 120. This may involve using standard wireless communication protocols, such as Wi-Fi or cellular networks, or it could involve using specialized communication protocols designed for railway operations.

In some embodiments, communication system 108 may include one or more dedicated short-range communications (DSRC) devices. These devices are designed to provide reliable, high-speed wireless communication over short distances, making them ideal for communication with stations positioned near the tracks. The DSRC devices could support both public and private data communications, allowing them to exchange information with a wide range of devices and systems. For example, DSRC devices may be used to communicate with sensors or control systems located at railway stations, crossings, or other points of interest along the tracks.

In addition to DSRC devices, communication system 108 may also include other types of communication devices or technologies. For instance, communication system 108 may include long-range communication devices for communicating with remote control stations or other trains over longer distances. Communication system 108 may also include satellite communication devices for global positioning or communication with satellite-based systems. Furthermore, communication system 108 may also include wired communication devices (e.g., Ethernet, cables) for connecting with onboard systems or devices, such as control system 116, computing system 114, and sensor system 106.

Communication system 108 may also be designed to support different types of data communications. For example, communication system 108 may support real-time data communication for immediate control or monitoring purposes. Communication system 108 may also support batch data communication for transmitting larger amounts of data at scheduled intervals. Moreover, communication system 108 may support secure data communication for transmitting sensitive or confidential information, such as operational data or safety information.

Power system 110 represents one or multiple power sources that can supply power to different components of motive system 100 and/or railway vehicle 102. In some cases, power system 110 may be shared across multiple railway vehicles within a train set. For instance, direct electrical connections can exist between power systems on different railway vehicles within a train. In addition, multiple power systems may be used to share energy in optimal ways, such as using an overcharged battery pack to kinetically recharge a depleted or lower state of charge battery pack. Batteries can be recharged during operation of railway vehicle 102, such as through regenerative braking, or they can be replaced or recharged during stops. In addition to batteries, power system 110 may also use petroleum-based fuels or gas-based fuels. These energy sources can provide a high amount of energy, making them suitable for long-distance travel or heavy-duty operations. Alternatively, the power system 110 could use solar panels or other types of renewable energy sources. These sources can provide a sustainable and environmentally-friendly source of power, although their output can be variable and dependent on environmental conditions.

In some embodiments, the power system 110 may include a combination of different power sources. For example, it could include a combination of batteries, capacitors, and/or flywheels. This hybrid approach can provide the benefits of multiple power sources, such as the high energy density of batteries, the rapid charge and discharge capabilities of capacitors, and the mechanical energy storage of flywheels.

Braking system 112 may represent one or multiple supplementary brake systems that motive system 100 may include to further enhance performance of railway vehicle 102. The primary braking system can be pneumatic, with brake airlines pressurized from compressors on board the locomotive, and used in conjunction with braking system 112. For instance, braking system 112 may be a regenerative brake system that can serve as an energy recovery mechanism that also slows down the railway vehicle by converting its kinetic energy into a form that can be used immediately or stored until needed. For instance, braking system 112 may convert kinetic energy into energy stored by one or more batteries of power system 110. In some instances, braking system 112 can dissipate the energy as heat, such as when the battery storage on railway vehicle 102 is full. This heat dissipation can help prevent overheating of the batteries and prolong their lifespan.

In some embodiments, braking system 112 can be a regenerative braking system that can be used to feed electricity directly into the electrical grid through overhead catenary lines or other technologies (e.g., third rails used for power). Braking system 112 may also be used during short sections of track without requiring full electrification of the track lines to take advantage of traditional un-electrified rail as well as short electrified sections for recharging and returning power to the grid.

Computing system 114 represents one or multiple computing devices that can perform operations, such as the various operations described herein. Computing system 114 may include one or multiple processors that can execute instructions stored in a non-transitory computer readable medium (e.g., data storage). The instructions can enable computing system 114 to operate with the various subsystems of motive system 100 and other computing devices (e.g., remote computing system 118).

In some examples, motive system 100 may use communication system 108 to facilitate the exchange of data and control signals with remote computing system 118. This communication could be facilitated over wireless connection 120, which could involve standard wireless communication protocols, such as Wi-Fi or cellular networks, or it could involve specialized communication protocols designed for railway operations.

In addition to its computational and communication capabilities, computing system 114 may also include one or multiple user interface elements. These elements enable users to interact with the system, providing instructions and receiving information from the motive system 100. For instance, computing system 114 may include one or more input/output devices, such as a tablet touchscreen or industrial hand-controller for intuitive control and data input, a speaker for auditory feedback or alerts, and a microphone for voice commands or communication.

In some embodiments, computing system 114 is designed with a focus on reliability and resilience. For instance, computing system 114 may be designed to be self-redundant, offering duplex or triplex redundancy in case of a partial system failure. This design allows computing system 114 to continue operations safely in the event of a failure, ensuring that railway vehicle 102 can maintain its mission, operation, and safety. Furthermore, the redundant system can also serve as a verification and validation mechanism for the sensor inputs received from sensor system 106. This can enhance the accuracy and reliability of the data used by the system, further improving its performance and safety.

Control system 116 can include one or multiple components designed to assist in the operations of railway vehicle 102. For instance, control system 116 can include components that enable control of other components of motive system 100 and/or a proportional-integral- derivative controller (PID controller or three-term controller) that is a control loop mechanism employing feedback that is widely used in industrial control systems and a variety of other applications requiring continuously modulated control. In some examples, remote computing system 118 may communicate control instructions to control system 116, which can then execute a control strategy based on the control instructions.

Remote computing system 118 represents a computing system that may provide information and/or control instructions to motive system 100 and/or railway vehicle 102. For instance, remote computing system 118 may be a smartphone, server, laptop, tablet, wearable computing device, industrial hand-controller and/or another type of device that enables inputs to different components within motive system 100. Remote computing system 118 may provide a user interface that enables remote control of railway vehicle 102.

Motive system 100 may include other pneumatic elements for auxiliary services, such as dump, gate, hatch, or door actuation. These systems can be actuated via solenoids remotely or manually. Gate, hatch, or door actuation can be supplied from the same compressors or completely separate air systems from the brake air infrastructure. In addition, motive system 100 can also include additional systems, such as a cooling system that can service the needs of other systems. For instance, the cooling system can cool onboard battery storage, electric motors, inverters using liquid or air cooled subsystems in order to keep the components in satisfactory operating temperatures. The cooling system can also be used to cool the compressors and air drying/treating equipment for the pneumatic systems. This can help to maintain the efficiency and reliability of these systems, as well as prolong their lifespan. The cooling systems could be interconnected in various ways to optimize their performance and efficiency. For example, they could be linked in a single loop, allowing the coolant to flow through all the systems in a continuous cycle. Alternatively, they could be arranged in series or parallel configurations, depending on the thermal loads and cooling requirements of the different systems. In some cases, each system may have its own dedicated subsystem for cooling. This can provide more precise control over the cooling of each system and can be beneficial in situations where the systems have different cooling requirements or operating conditions.

In other cases, a combination of a master cooling system and additional cooling subsystems can be used. The master cooling system could provide the primary cooling for the major components of motive system 100, while the additional cooling subsystems could provide supplementary cooling for specific components or systems. This hybrid approach can provide a balance between efficiency and flexibility, allowing the cooling system to adapt to a wide range of operational scenarios and environmental conditions.

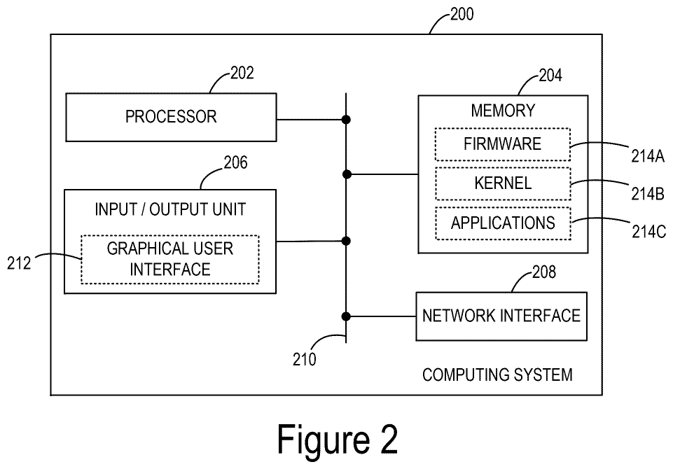

FIG. 2 is a block diagram of computing system 200, illustrating some of the components that could be included in a computing device arranged to operate in accordance with the embodiments herein. As such, computing system 200 may be implemented as computing system 114 of motive system 100 and/or remote computing system 118 shown in FIG. 1. In some examples, computing system 200 may communicate with one or more accessories attached to a railway vehicle via one or more bearing adapters.

In the example embodiment shown in FIG. 2, computing system 200 includes processor 202, memory 204, input/output unit 206, and network interface 208, all of which may be connected by a system bus 210 or a similar mechanism. In some example embodiments, computing system 200 may include other components and/or peripheral devices (e.g., detachable storage and/or sensors).

Processor 202 may be one or more of any type of computer processing element, such as a central processing unit (CPU), a co-processor (e.g., a graphics processor), a digital signal processor (DSP), a network processor, and/or a form of integrated circuit (e.g., a field programmable gate array (FPGA)) or controller that performs processor operations. As such, processor 202 may be one or more single-core processors and/or one or more multi-core processors with multiple independent processing units. In addition, processor 202 may also include register memory for temporarily storing instructions being executed and related data, as well as cache memory for temporarily storing recently-used instructions and data.

Memory 204 may be any form of computer-usable memory, including but not limited to random access memory (RAM), read-only memory (ROM), and non-volatile memory. This may include flash memory, hard disk drives, solid state drives, rewritable compact discs (CDs), rewritable digital video discs (DVDs), and/or tape storage, as just a few examples. Computing system 200 may include fixed memory as well as one or more removable memory units, the latter including but not limited to various types of secure digital (SD) cards. As an example result, memory 204 can represent both main memory units as well as long-term storage.

Memory 204 may store program instructions and/or data on which program instructions may operate. By way of example, memory 204 may store these program instructions on a non-transitory, computer-readable medium, such that the instructions are executable by processor 202 to perform any of the methods, processes, or operations disclosed in this specification or the accompanying drawings.

As shown in FIG. 2, memory 204 may include firmware 214A, kernel 214B, and/or applications 214C. Firmware 214A may be program code used to boot or otherwise initiate some or all of computing system 200. Kernel 214B may be an operating system, including modules for memory management, scheduling and management of processes, input/output, and communication. In addition, kernel 214B may also include device drivers that allow the operating system to communicate with the hardware modules (e.g., memory units, networking interfaces, ports, and busses) of computing system 200. Applications 214C may be one or more user-space software programs, such as web browsers or email clients, as well as any software libraries used by these programs. In some examples, applications 214C may include one or more control systems 116, neural network applications and other deep learning-based applications. Memory 204 may also store data used by these and other programs and applications.

Input/output unit 206 may facilitate user and peripheral device interaction with computing system 200, sensors, and/or other computing systems, such as computing systems on other railway vehicles and/or positioned remote from a train. Input/output unit 206 may include one or more types of input devices, such as a keyboard, a mouse, one or more touch screens, sensors, biometric sensors, and so on. Similarly, input/output unit 206 may include one or more types of output devices, such as a screen, monitor, printer, speakers, and/or one or more light emitting diodes (LEDs). Additionally or alternatively, computing system 200 may communicate with other devices using a universal serial bus (USB) or high-definition multimedia interface (HDMI) port interface, for example. In some examples, input/output unit 206 can be configured to receive data from other devices. For instance, input/output unit 206 may receive sensor data from sensors, such as sensors positioned on a railway vehicle. As shown in FIG. 2, input/output unit 206 includes Graphical User Interface (GUI) 212, which can be configured to provide information to a user. GUI 212 may involve one or more display interfaces, or another type of mechanism for conveying information and receiving inputs. Some common rail techniques can involve signal lighting, horns, and bells, which can be implemented via input/output unit 206. With many techniques in traditional rail being visual and auditory in nature, these techniques in addition to more advanced signaling and human machine interfaces can be implemented.

Network interface 208 may take the form of one or more wireline interfaces (e.g., Ethernet) and/or enable communication over one or more wireless interfaces, such as IEEE 802.11 (Wi-Fi), BLUETOOTH®, private wireless network (using the Citizens Broadband Radio Service (CBRS)), global positioning system (GPS), 3G, 4G, 5G, or a wide-area wireless interface. In addition, other forms of physical layer interfaces and other types of standard or proprietary communication protocols may be used over network interface 208.

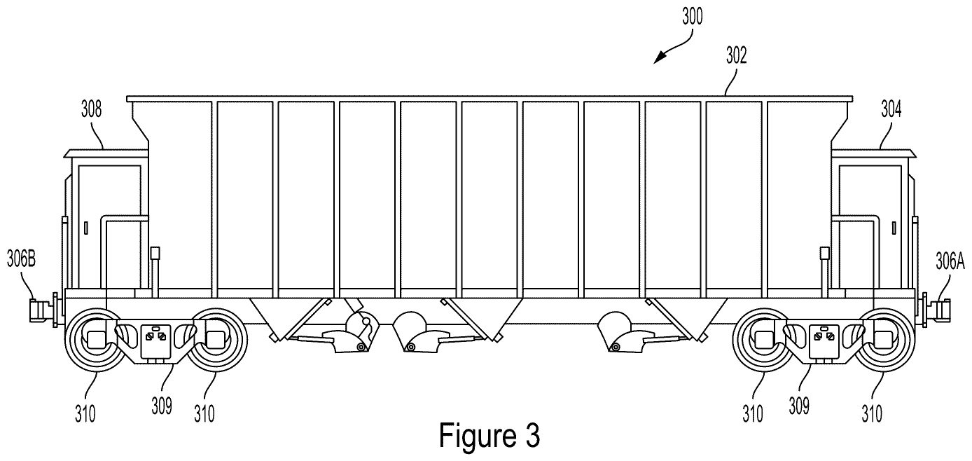

FIG. 3 illustrates a configuration of railway vehicle 302 equipped with motive system 300. In the example embodiment, motive system 300 is implemented on railway vehicle 302 and includes sensor system 304 positioned near front coupler 306A and battery storage 308 located near rear coupler 306B. Railway vehicle 302 may be controlled according to a route and a control strategy determined by a computing system performing techniques presented herein.

In the example embodiment, railway vehicle 302 is shown as a freight vehicle designed to carry materials and other cargo between locations. Railway vehicle 302 has front side 312 and rear side 314, which can each be attached to different railway vehicles within a trainset/consist via front coupler 306A and rear coupler 306, respectively. As shown, railway vehicle 302 includes bogies 309 (or trucks) that enable movement on wheels 310. As such, motive system 300 can involve installation of one or multiple components (e.g., electric motors, braking systems) on bogies 309 via one or more bearing adapters and other components of railway vehicle 302. Railway vehicle 302 can have alternative configurations within other embodiments. In addition, railway vehicle 302 can be part of a train that includes one or multiple railway vehicles equipped with motive systems 300.

Motive system 300 can be implemented as motive system 100 shown in FIG. 1 and can include one or more electric drive systems and an auxiliary braking system that can enable motive system 300 to perform operations disclosed herein that can enhance overall performance of railway vehicle 302. For instance, motive system 300 may include one or multiple electric drivetrains that can be used to turn axles connected to wheels 310. In addition, motive system 300 may also include a regenerative braking system that can be used to convert energy from one or more axles and/or wheels 310 and deliver energy to battery storage 308 during braking applications.

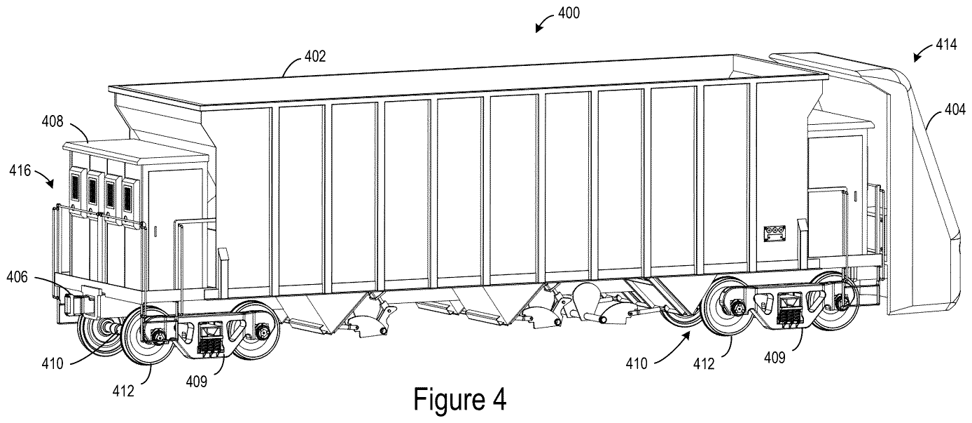

FIG. 4 illustrates another configuration of railway vehicle 402 configured with motive system 400, which can similarly include components of motive system 100 shown in FIG. 1 and may enable railway vehicle 402 to operate autonomously and without locomotives.

Railway vehicle 402 is similar to railway vehicle 302 shown in FIG. 3, but differs at the front end of railway vehicle 402. In particular, motive system 400 implemented on railway vehicle 402 includes sensor component 404 that may include additional sensors (e.g., cameras, radar) to enable railway vehicle 402 to perform operations typically completed by a locomotive. Railway vehicle 402 includes coupler 406 and bogies 409 configured with axles 410 and wheels 412 as shown in FIG. 4. As such, bogies 409 and disclosed bearing adapters can be used to position motors and/or other components that enable railway vehicle 402 to be self-propelled. In some examples, regenerative braking components can be attached to axles 410, bogies 409, and/or wheels 412. In addition, housing 408 may include batteries and/or other components for motive system 400. Railway vehicle 402 has front “A” side 414 and rear “B” side 416 as shown in FIG. 4. Rear side 416 can be coupled to another railway vehicle within a train set via coupler 406.

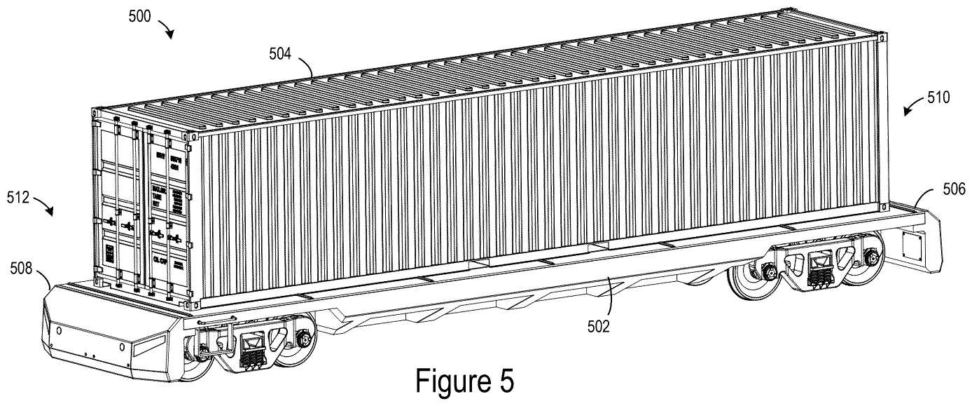

FIG. 5 illustrates an additional configuration of railway vehicle 502 configured with motive system 500, which can similarly include components of motive system 100 shown in FIG. 1 and may enable railway vehicle 502 to operate autonomously and without locomotives. Similar to the examples shown in FIG. 3 and FIG. 4, motive system 500 can include components that can enhance performance of railway vehicle 502.

In the example embodiment, railway vehicle 502 has a flat design to enable one or multiple containers (e.g., shipping container 504) to be positioned on top. Motive system 500 implemented on railway vehicle 502 includes front component 506 positioned at front “A” side 510 and rear component 508 positioned at rear “B” side 512. One or both of front component 506 and rear component 508 can include various components of motive system 500, such as sensors, energy storage (e.g., batteries), etc. In addition, the bogies of railway vehicle 502 can similarly include components of motive system 500, such as regenerative brakes, motors, etc. Motive system 500 can also be designed for standard coupling interfaces and may use one or multiple bearing adapters disclosed herein.

In addition, each railway vehicle 302, 402, 502 can further include additional components, such as emergency brakes, lights, bells, and horns.

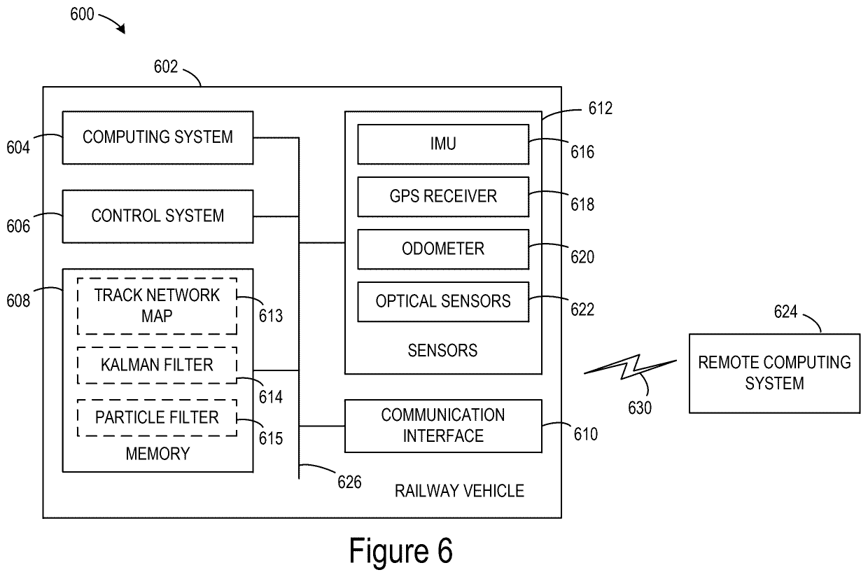

FIG. 6 illustrates a block diagram for a system for multi-sensor fusion railway vehicle localization. System 600 comprises railway vehicle 602 and remote computing system 624. In addition, system 600 may include additional components in some examples, such as other railway vehicles, locomotives, and remote computing systems. System 600 can facilitate positioning and navigation of railway vehicle 602 within the track network by combining data from multiple sensors and comparing the combined data with track network map 613. In some cases, track network map 613 represents a custom digital representation of the tracks available to railway vehicle 602, enabling system 600 to precisely identify a location of railway vehicle 602, including providing details of the distance and estimated time to travel to points of interests (e.g., a loading area, a stop or drop zone), and other parameters.

Railway vehicle 602 represents various types of vehicles capable of traveling on tracks, such as a freight car retrofitted with sensors, compute, communication components, motors, and power sources. As shown in FIG. 6, railway vehicle 602 may include various components, such as computing system 604, control system 606, memory 608 with track network map 613, Kalman filter 614, particle filter 615, communication interface 610, and sensors 612. These components are connected via connection mechanisms 626, which can represent various types of wired and/or wireless connections. In some cases, railway vehicle 602 may include additional components not shown in FIG. 6.

Computing system 604 represents one or more computing devices configured to perform localization operations presented herein and is shown linked to control system 606 to manage railway vehicle 602 based on processed sensor data. For instance, computing system 604 can be an onboard system, a remote system like a server in a data center or a cloud-based system, and/or a combination of onboard and off board computing devices. During operation, computing system 604 may communicate with sensors 612 and control system 606 via wired or wireless connections to perform operations, such as receiving sensor data, performing non-linear sensor fusion to determine the vehicle's 3D position, projecting this onto track network map 613 to determine a 2D location of railway vehicle 602 within the train network, and leveraging the 2D location in conjunction with control system 606. These operations may occur in real-time or near real-time for continuous position updates.

Control system 606 represents hardware and/or software configured to use the 2D location information to control navigation, speed, braking, and other operations of railway vehicle 602. In some cases, computing system 604 and/or control system 606 may be part of a larger system including collision avoidance or scheduling subsystems. As such, the 3D and 2D location information generated perform disclosed techniques may be provided to these subsystems to enhance their functionality and the overall performance of railway vehicle 602.

As shown, railway vehicle 602 may include memory 608, which can be any form of computer-usable memory, including RAM, ROM, and non-volatile memory. Memory 608 may store program instructions, data, recorded data, track network map 613, Kalman filter 614, and particle filter 615. Memory 608 can also represent memory distributed across multiple railway vehicles and/or multiple computing devices. For instance, memory 608 may include sub memory located at remote computing system 624. As such, communication interface 610 may be used for data exchange with external systems, including remote computing system 624.

Sensors 612 represents various types of sensors that railway vehicle 602 may include. In the example embodiment, sensors 612 include IMU 616, GPS receiver 618, odometer 620, optical sensors 622 (e.g., cameras, lidar), and additional sensors (e.g., ultrasonic sensors, temperature sensors, pressure transducer sensors). Sensors 612 gather various types of data continuously or intermittently as railway vehicle 602 moves along a track. The sampling rate may be adjusted based on factors like railway vehicle speed, track complexity, and/or environmental conditions. The sensor data is transmitted to computing system 604 for processing, allowing for continuous updates of the railway vehicle's position estimation. This transmission can occur wirelessly or via wired connections, depending on the specific implementation of the system.

Computing system 604 may determine 3D positions of railway vehicle 602 by using the sensor data generated by sensors 612. For instance, computing system 604 may perform non-linear sensor fusion to combine sensor data originating from multiple sensors positioned on railway vehicle 602. The non-linear sensor fusion algorithm may be configured to handle different types of sensor data, such as geographical location data from GPS receiver 618, motion and attitude data from IMU 616, distance traveled data from odometer 620, and image or other optical data from a camera or lidar sensor. The algorithm may also be configured to handle different types of system dynamics, such as the motion of railway vehicle 602 along the rail or the changes in the environment around railway vehicle 602. Non-linear sensor fusion may be particularly useful when sensors 612 provide different types of data or when the relationship between the sensor data and the state of railway vehicle 602 is non-linear.

In some cases, computing system 604 may use Kalman filter 614 stored in memory 608. Kalman filter 614 may represent a recursive algorithm that can use a series of measurements observed over time, containing statistical noise and other inaccuracies, to produce estimates of unknown variables that tend to be more accurate than those based on a single measurement alone. In general, a Kalman filter may be particularly useful when the sensor data is noisy or when the system dynamics are complex. In some embodiments, the Kalman filter used may be an extended Kalman filter (EKF) or an unscented Kalman filter (UKF). The EKF is a variant of the Kalman filter that can handle nonlinear system dynamics by linearizing the system dynamics and measurement functions at the current state estimate. The UKF, on the other hand, is another variant of the Kalman filter that can handle highly non-linear system dynamics without the need for linearization. Computing system 604 may switch between the EKF and the UKF based on the specific characteristics of railway vehicle 602 and the sensor data generated by sensors 612. For instance, the EKF may be preferred when the system dynamics and measurement functions are mildly nonlinear and the process and measurement noises are small, while the UKF may be preferred when the system dynamics and measurement functions are highly non-linear and the process and measurement noises are large.

Computing system 604 may project the 3D position of railway vehicle 602 onto a predefined map of the track network (e.g., track network map 613) to determine a 2D location of railway vehicle 602 within the track network. For instance, track network map 613 may include a series of GPS points taken along the centerline of the track network, representing the layout and geometry of the tracks. This map may be stored in memory 608 of computing system 604 or in a remote database accessible to computing system 604.

In some examples, track network map 613 is a digital representation of tracks available for travel by railway vehicle 602. The digital representation may use nodes, segments, and points of interest (POIs) to convey information about the track network. In particular, each of these components may be represented digitally in a way that facilitates their use in the navigation and localization process.

Within the digital representation, nodes may be used to represent any physical infrastructure that joins or terminates sections of a track. The nodes may be stored digitally as structures containing various information (metadata), such as geographic coordinates, IDs, and speed limits associated with portions of the tracks. In some cases, the nodes may be further divided based on characteristics into bumper nodes, joint nodes, or switch nodes. For instance, bumper nodes may be used to represent the ends of a track segment (a portion of the track) when there are not any connecting segments at that junction. For example, bumper nodes may be used at the furthest extents of tracks or at a dead end. In some instances, bumper nodes could also be temporarily used for track maintenance or construction. Unlike bumper nodes, joint nodes may be used to represent where two track segments come together. This could occur, for instance, when there is a speed limit change along the length of a track (e.g., to represent a transition from a first speed limit to a second speed limit). In some cases, a joint node could also be used at a switch that has had one leg of its joining track decommissioned. The remaining type of node, switch nodes, may be used to represent the locations of switches along tracks in the track network and may be used to connect three segments of track. More complicated switch setups could also be modeled as multiple switches connected concurrently. The different legs of a switch may have names, such as facing, normal, and reverse, which conveys additional information about the portions of tracks connecting via the switch. As such, the direction of travel associated with switch nodes may also be defined, such as crossing the switch in a normal direction, reverse direction, or facing direction. In some cases, a change from the reverse segment to the normal segment may involve multiple switching events, such as crossing the switch in a facing direction followed by a normal direction.

Segments, as used within the digital representation of the track network, may be defined as a stretch of track between two nodes. These segments may be digitally represented using segment details (e.g., unique identifiers) and an array of track points. Each track point may represent geographic data (e.g., longitude, latitude, and elevation) and any associated directional speed limits. The segments may also include information about the segment length and direction. As such, segments may be defined during generation of track network map 613 and can serve as the edges of a graph network, with the purpose of the nodes being to connect and allow traversal between nodes. In reality, representing a segment as a continuous function between nodes could be challenging due to the complexity of the geography covered by the segment. Therefore, in some cases, the segments themselves may be represented by a collection of GPS points. This collection may also include the points on the nodes themselves, allowing for a holistic representation of the segment from start to end.

Points of Interest (POIs) within the digital representation of track network map 613 may be similar to nodes in the information they contain, but POIs might not represent the terminal extents of a segment of track. Rather, POIs may represent a point along the track that can be used by an operator or customer to dispatch their system in a meaningful way (switches, crossings, bridges, tunnels, elevated track). The POIs may be represented via location data and descriptive information. POIs can be defined by operators, users of system 600, and/or other sources within examples. Computing system 604 may perform disclosed operations to localize a position of railway vehicle relative to POIs, including determining estimated time to arrive each POI.

In some embodiments, the digital representation of track network map 613 may be used in conjunction with a Vehicle Management System (VMS), which may allow for the efficient and effective operation of railway vehicles using the digital map environment. In addition, in some examples, the digital representation of track network map 613 may include features, such as switch node directions, segment length calculation using cumulative distances between GPS points, track distance increasing/decreasing directions for navigation, and speed limits specified for different travel directions. These features may enhance the functionality and accuracy of the navigation and localization process.

The digital representation of nodes may include various attributes that are stored as part of track network map 613. For instance, the attributes may include, but are not limited to, geographic coordinates, such as latitude, longitude, and elevation. In some cases, the attributes may also include information related to the Universal Transverse Mercator (UTM) coordinate system. These coordinates may provide precise location information for each node, facilitating accurate navigation and localization. In particular, computing system 604 may leverage the precise information for each node to localize the 3D position of railway vehicle 602 onto the digital representation of track network map 613.

In some cases, each node may also be assigned a unique identifier (e.g., Node ID), which may be used to reference the node in the system. The Node ID may be an integer value, but other types of identifiers may also be used. In addition to the Node ID, each node may also have associated Segment IDs, which may identify the segments that are connected to the node. For instance, a switch node may have a Facing Segment ID, a Normal Segment ID, and a Reverse Segment ID, each corresponding to a different leg of the switch node. In addition, each node may also have associated speed limits for different directions of travel. For example, a node may have a Facing Speed Limit, a Normal Speed Limit, and a Reverse Speed Limit. These speed limits may be specified as double values, but other types of values may also be used within examples. The speed limits may be used to control the speed of railway vehicle 602 as it traverses the track network, enhancing safety and efficiency.

In some embodiments, the digital representation of nodes may be stored in memory 608 or remotely at remote computing system 624 using a suitable data structure with fields for each of the node's attributes, allowing the attributes to be easily accessed and manipulated by system 600. Other data structures and programming languages may also be used to store the digital representation of nodes, depending on the specific requirements of system 600. In some cases, the digital representation of nodes may be used in conjunction with other components, such as the sensor fusion algorithm and the track information, to determine the precise location of the railway vehicle 602 on the track network. This may involve using the node's geographic coordinates and speed limits to refine the position estimation and control the speed of railway vehicle 602, respectively.

In some cases, the process of using the 3D position to determine the location of railway vehicle 602 within the track network may involve using a method of the closest fit. This method may involve finding the point on the predefined map that is closest to the 3D position of railway vehicle 602, and assigning this point as the 2D location of railway vehicle 602 within the track network. This method may be particularly useful when the 3D position of railway vehicle 602 is close to the centerline of the track network, and the track network has a simple geometry with few parallel tracks or switches.

In other cases, a particle filter offers an effective method for localizing railway vehicle 602 relative to Points of Interest (POIs) represented in track network map 613. This probabilistic approach combines sensor data with the known track layout to estimate the position of railway vehicle 602 with high accuracy, providing real-time information about its location in relation to important points along its route. The process begins with an initialization step, where the particle filter generates a large number of particles, typically in the thousands, distributed across possible locations of railway vehicle 602 on track network map 613. Each of these particles represents a hypothesis of the position of railway vehicle 602 and carries a weight indicating its probability of being correct. This initial distribution allows the filter to consider multiple potential locations simultaneously.

As railway vehicle 602 moves along the track, the filter enters a prediction phase. In this step, it predicts the new position of each particle based on several factors: the previous position of the particle, sensor data from the vehicle (such as speed from the odometer and acceleration from the IMU), and the known track geometry from track network map 613, including curves and gradients. This prediction step effectively moves the particles along the tracks in track network map 613 according to the expected motion of vehicle 602, creating a new set of hypotheses about the current location of railway vehicle 602. Following prediction, the filter performs an update step. Here, it updates the weight of each particle based on how well it matches the observed sensor data and map information. GPS measurements are compared to particle positions, IMU data is checked against expected accelerations for each particle's location on the track, and other sensor data, such as from cameras or LiDAR, is compared to expected observations at each particle's position. Particles that better match the sensor data receive higher weights, indicating a higher probability of representing the true position of vehicle 602. The filter then undergoes a resampling phase, where particles with low weights are eliminated, and new particles are generated around the high-weight particles. This process concentrates the particles around the most likely positions of vehicle 602 on track network map 613, focusing the computational resources on the areas of highest probability and improving the accuracy of the localization over time.

After resampling, the filter estimates the position of railway vehicle 602. This may be calculated as the weighted average of all particle positions or by selecting the position of the highest-weight particle. This estimated position represents the best guess of the current location of railway vehicle 602 on track network map 613. Once the position of railway vehicle 602 is estimated on track network map 613, system 600 can easily calculate its position relative to POIs. It identifies the current track segment and the nearby POIs from track network map 613, then calculates the along-track distance to each POI by summing the lengths of track segments between the estimated position and the POI. Using the current speed of railway vehicle 602 and track data from map 613, computing system 604 can also estimate the time required to reach each POI. Weather, track condition and use, and other variables may also be considered.

This comprehensive process allows for accurate, real-time estimation of the location of railway vehicle 602 relative to POIs on track network map 613. The particle filter's ability to handle complex probability distributions makes it particularly well-suited for railway localization, where it can maintain accuracy even in challenging scenarios such as complex network topologies with multiple tracks or switches. By continuously updating and refining its estimates, the particle filter provides crucial information for efficient railway operations, precise scheduling, accurate location, and enhanced safety measures.

Computing system 604 and/or control system 606 may control railway vehicle 602 based on the location information derived from disclosed localization techniques. For instance, computing system 604 may communicate information (e.g., control signals) to control system 606 or other onboard systems, instructing the systems to perform certain operations based on the location information. As an example, computing system 604 may send a signal to control system 606 to reduce the speed of railway vehicle 602 when railway vehicle 602 is approaching certain features in the train network (e.g., approaching a curve) or to apply the brakes when railway vehicle 602 is approaching a station or other track infrastructure. This control may be performed in real time or near real time, enabling railway vehicle 602 to respond quickly to change in its location or the track conditions.

In some examples, remote computing system 624 uses a multi-faceted approach to distribute digital map information and updates to railway vehicles (including railway vehicle 602), ensuring all vehicles have access to the most current and accurate digital map data. Remote computing system 624 may use wireless communication 630, transmitting map updates over cellular networks to allow railway vehicles to receive updates in real-time as they travel. In areas with limited cellular coverage, satellite communication systems may be used to ensure continuous connectivity. Additionally, remote computing system 624 may leverage trackside communication infrastructure, such as Wi-Fi hotspots or dedicated short-range communication (DSRC) units placed at strategic locations along the railway network, enabling vehicles to quickly download map updates as they pass these points.

In some examples, to optimize bandwidth usage and ensure timely updates, remote computing system 624 may implement a differential update system. Instead of transmitting entire map files, remote computing system 624 sends only the changes or differences from the previous version, reducing data transfer requirements and allowing for more frequent updates. Remote computing system 624 may also use a prioritization mechanism for updates. Critical changes, such as temporary speed restrictions or track closures, are given higher priority and transmitted immediately to all affected vehicles, while less urgent updates, like minor adjustments to track geometry, might be scheduled for off-peak hours or when vehicles are stationary.

To keep the digital map information current for optimal use, remote computing system 624 integrates data from various sources. Sensor data from railway vehicles plays a crucial role, as vehicles equipped with various sensors detect discrepancies between the current map and the actual environment during their travels. This data is transmitted back to remote computing system 624 for analysis and potential map updates. Maintenance reports are another vital source of information, with details of track maintenance or modifications being input into the system for immediate map updates. Periodic resurveying of the track network using advanced techniques like LiDAR captures gradual changes over time, with this data being processed and integrated into the map by remote computing system 624. Remote computing system 624 may also be linked to railway infrastructure management databases, automatically incorporating planned changes once they are implemented. Advanced machine learning algorithms analyze data from multiple sources over time, automatically detecting and classifying changes in the railway environment, with remote computing system 624 using these insights to update the map.

In some examples, environmental factors are also considered in the update process. Information about weather conditions, vegetation growth, land/water topology, elevation maps,, or other environmental factors that may affect railway operations is incorporated into the map updates. Remote computing system 624 also leverages crowdsourced reports, with train operators and maintenance crews able to report discrepancies or changes they observe. Remote computing system 624 verifies these reports and incorporates them into the map as appropriate. Integration with traffic management systems allows real-time data about track usage, temporary speed restrictions, or other operational changes to be continuously integrated into the map updates. By combining these various data sources and update mechanisms, remote computing system 624 ensures that the digital map remains a highly accurate and up-to-date representation of the railway network. This current information is then distributed to railway vehicles, enabling them to operate with optimal efficiency and safety based on the most recent and accurate map data available.

In some examples, the 3D location information and/or 2D location information of railway vehicle 602 within the track network may be provided to a collision avoidance system. The collision avoidance system may be located onboard railway vehicle 602 and/or remote from railway vehicle 602. The collision avoidance system may be configured to monitor the travel of railway vehicle 602 and prevent potential collisions with other railway vehicles or obstacles. As such, the collision avoidance system may use the location information to determine the proximity of railway vehicle 602 to other railway vehicles or obstacles, and take appropriate actions if a potential collision is detected. For example, the collision avoidance system may send a warning signal to control system 606 of railway vehicle 602, instructing control system 606 to reduce speed or apply the brakes of railway vehicle 602.

In some embodiments, the collision avoidance system may be positioned remote from railway vehicle 602 and may be configured to monitor the travel of multiple railway vehicles within the track network. The remote collision avoidance system may receive 2D location information of each railway vehicle from their respective computing systems, and use this information to monitor the proximity of the railway vehicles to each other and to potential obstacles. If a potential collision is detected, the remote collision avoidance system may send a warning signal to the control system of the relevant railway vehicle or vehicles, instructing them to take appropriate actions to avoid the collision. In some cases, the remote collision avoidance system may be part of a centralized control center that oversees the operation of the entire track network. The centralized control center may have access to the predefined map of the track network and other relevant information, such as the schedule of the railway vehicles, the status of the tracks, and so on. The centralized control center may use this information in conjunction with the 2D location information of the railway vehicles to optimize the operation of the track network, such as by minimizing delays, coordination in rail yards, maximizing the utilization of the railway vehicles, or enhancing the safety of the railway operations.

In some embodiments, the collision avoidance system may be an onboard system that is coupled to railway vehicle 602. This onboard collision avoidance system may receive the 2D location information directly from computing system 604 of railway vehicle 602, and use this information to monitor the proximity of railway vehicle 602 to other railway vehicles or obstacles in its immediate vicinity. The onboard collision avoidance system may be particularly useful in situations where real-time response is critical, such as when railway vehicle 602 is traveling at high speed or in dense traffic conditions.

In some aspects, computing system 604 may estimate a remaining travel time for railway vehicle 602 to reach a destination based on the 2D location of railway vehicle 602 within the track network. This estimation may involve calculating the distance from the current 2D location of railway vehicle 602 to the location of the destination on the predefined map of the track network, and then dividing this distance by the current or expected speed of railway vehicle 602. The speed of the railway vehicle may be determined based on the sensor data, such as the data from odometer 620 or IMU 616. In some cases, the estimation of the remaining travel time may take into account various factors, such as the track conditions, the traffic conditions, or the operational constraints of railway vehicle 602. For instance, computing system 604 may adjust the estimated travel time based on the expected delays due to track maintenance, traffic congestion, or speed restrictions. Computing system 604 may also consider the acceleration and deceleration capabilities of railway vehicle 602, as well as its maximum allowable speed, when estimating the remaining travel time.

In other embodiments, computing system 604 may use a model to estimate the remaining travel time. For example, computing system 604 may use a machine learning algorithm that has been trained on historical travel data to predict the travel time based on the current location (e.g., the 2D location within the track network), speed, and other relevant factors. This machine learning algorithm may be able to capture complex patterns and dependencies in the travel data, which can enable the output to provide a more accurate estimation of the remaining travel time. Computing system 604 may distribute this accurate estimation to other computing devices, such as other railway vehicles operating as part of the train that includes railway vehicle 602.

In addition, the estimated remaining travel time may be provided to control system 606 of railway vehicle 602 or to a scheduling system. Control system 606 may use this information to plan the speed or braking of railway vehicle 602. The scheduling system may use this information to optimize the operation of railway vehicle 602 within the track network, such as by minimizing delays, adjusting route, or maximizing the utilization of components (e.g., motor and batteries) operating onboard and/or propelling railway vehicle 602. The estimated remaining travel time may also be displayed to the operator of the railway vehicle or communicated to a remote control center, such as remote computing system 624 or a centralized control center. Computing system 604 may communicate real-time updates on the progress of railway vehicle 602 to various devices and systems.

In some aspects, railway vehicle 602 may be a freight railway vehicle with sensors retrofitted onto different existing components via mechanical connections. The retrofitting process may involve attaching the sensors to exterior and/or interior locations on the freight railway vehicle using various types of mechanical connections, such as screws, bolts, clamps, or adhesive mounts. The specific type of mechanical connection used may depend on the type of sensor, the material of the railway vehicle, and other factors. In some cases, the sensors may be retrofitted onto the freight railway vehicle in locations that provide optimal coverage and signal quality. For example, GPS receiver 618 may be mounted on the roof of railway vehicle 602 to capture a clear view of the sky, while IMU 616 and odometer 620 may be mounted near the wheels or axles to accurately measure the motion of the railway vehicle. Similarly, the freight railway vehicle may include one or more electric motors that can obtain power stored by onboard battery systems. The electric motors can be positioned near an axle or an end cap of the axle to enable the electric motor to rotate the axle and connected wheels. The battery system can be located onboard the freight railway vehicle and supply power to the electric motors, sensors 612, and other components (e.g., communication interface 610).

In some embodiments, sensors 612 may be retrofitted onto the freight railway vehicle using mechanical connections in a manner that minimizes interference with the operation of the railway vehicle. For example, sensors 612 may be mounted in locations that do not obstruct the view of the operator, do not interfere with the loading or unloading of cargo, and do not generate excessive noise or vibration. In some aspects, the retrofitting process may also involve connecting sensors 612 to the power supply of the freight railway vehicle and to computing system 604 that processes the sensor data. This may involve running wires or cables from sensors 612 to the power supply and computing system 604, and/or it may involve setting up a wireless connection between sensors 612 and computing system 604. The specific method of connection used may depend on the requirements of each sensor and computing system 604, as well as the layout and design of the freight railway vehicle.

In some cases, the retrofitting process may be performed by a technician or engineer, using standard tools and equipment. In other cases, the retrofitting process may be automated or semi-automated, using robotic systems and/or other automated equipment. The retrofitting process may be performed at a maintenance facility, at a railway yard, or at any other suitable location. In some embodiments, the retrofitting process may be reversible, allowing sensors 612 to be removed or replaced without causing permanent damage to the freight railway vehicle. This may be particularly useful for maintenance or upgrade purposes, or when the freight railway vehicle is retired or repurposed. In other embodiments, the retrofitting process may be designed to ensure the durability and reliability of sensors 612 under the harsh conditions typically encountered in railway operations, such as vibrations, impacts, extreme temperatures, corrosion, or adverse weather conditions. This may involve using ruggedized sensors, protective housings, or special mounting techniques.

In some aspects, the retrofitting process may also involve calibrating sensors 612 to ensure accurate and reliable operation. This may involve adjusting the settings of sensors 612, testing the sensors under various conditions, or comparing the sensor data with reference data. The calibration process may be performed as part of the retrofitting process, or it may be performed separately, either before or after the retrofitting process. In some cases, the retrofitting process may also involve integrating the sensors with other systems of the freight railway vehicle, such as the control system, the collision avoidance system, or the scheduling system. This may involve configuring the sensors to communicate with these systems, or it may involve modifying these systems to accept and process the sensor data. The integration process may be performed as part of the retrofitting process, or it may be performed separately, either before or after the retrofitting process. In some embodiments, the retrofitting process may be customized for each freight railway vehicle, taking into account the specific characteristics and requirements of the vehicle. In other embodiments, the retrofitting process may be standardized for a fleet of freight railway vehicles, which can result in efficient and cost-effective deployment of sensors 612.

In some embodiments, the retrofitting process may also involve setting up a monitoring or diagnostic system for the retrofitted sensors, enabling remote monitoring of the sensor performance, early detection of sensor failures, or predictive maintenance of the sensors. This may involve installing additional hardware or software, setting up a communication link with a remote monitoring center (such as remote computing system 624), or setting up alerts or notifications for certain sensor conditions. In other embodiments, the retrofitting process may also involve setting up a data management system for the sensor data, allowing for efficient storage, retrieval, analysis, or sharing of the sensor data. This may involve setting up a database or data warehouse, setting up a data processing or analysis system, and/or setting up a data sharing or collaboration platform.

In some aspects, the retrofitting process may also involve setting up a power management system for the retrofitted sensors that allows for efficient use of power, extended battery life, and/or reduced power consumption. This may involve installing additional power sources (e.g., battery system, regenerative braking), setting up a power distribution or regulation system, and/or setting up a power saving or conservation mode. In some cases, the retrofitting process may also involve setting up a security system for the retrofitted sensors, protecting the sensors and the sensor data from unauthorized access, tampering, or theft. For instance, the retrofit can involve installing physical security measures, setting up a network security system, and/or setting up a data encryption or authentication system.

In some embodiments, the retrofitting process may also involve setting up a user interface for the retrofitted sensors that enables the operators or maintenance personnel of the freight railway vehicle to interact with computing system 604, sensors 612, and/or the sensor data. This may involve installing a display or control panel, setting up a software interface, and/or setting up a voice or gesture recognition system. In other embodiments, the retrofitting process may also involve setting up a backup or redundancy system for the retrofitted sensors, which can enable the continued operation of the freight railway vehicle in the event of a sensor failure. This may involve installing additional sensors, setting up a sensor switching or failover system, and/or setting up a sensor error detection or correction system. In some aspects, the retrofitting process may also involve setting up a calibration or adjustment system for the retrofitted sensors that allows for periodic calibration or adjustment of the sensors to maintain accurate and reliable operation. This may involve installing calibration equipment, setting up a calibration procedure, and/or setting up a calibration schedule or reminder system.

In some examples, railway vehicle 602 may be a powered freight railway vehicle that includes a motor configured to provide torque to rotate at least one axle of railway vehicle 602. The motor may be an electric motor, a diesel motor, or any other type of motor suitable for propelling a railway vehicle. In some cases, the motor may be configured to provide variable torque, allowing for adjustable speed control of railway vehicle 602. The motor may be coupled to the axle or axles of railway vehicle 602 through a transmission system, which may include gears, belts, chains, or other mechanical components.

In some embodiments, the freight railway vehicle may also include a battery configured to supply power to the motor. The battery may be a rechargeable battery, such as a lithium-ion battery, a nickel-metal hydride battery, or a lead-acid battery. The battery may be configured to store electrical energy and deliver this energy to the motor when needed. The battery may be charged by an onboard generator, an external power source, or through regenerative braking. In some cases, the battery may also supply power to sensors 612 and computing system 604.

In some aspects, different energy sources may be used to power sensors 612 and computing system 604. For example, a battery may be used for portable applications, or the system could be powered directly from the electrical system of railway vehicle 602. The choice of energy source may depend on various factors, such as the power requirements of each sensor, computing system 604, the availability of power sources, and the operational constraints of railway vehicle 602.

In some aspects, system 600 may be integrated with a scheduling system to optimize the operation of the rail network. The scheduling system may use the 2D location of railway vehicle 602 within the track network to plan the movement of railway vehicle 602 and other vehicles within the network. For instance, the scheduling system may use the location information to determine the optimal departure and arrival times for railway vehicle 602, to avoid conflicts with other vehicles, or to maximize the utilization of the tracks. The scheduling system may also use the location information to adjust the schedule in real time based on the actual progress of the railway vehicle, such as in the case of delays or early arrivals.

In some embodiments, power management techniques may be implemented to extend the battery life or reduce the power consumption of components that are located onboard railway vehicle 602. These techniques may include, for example, adjusting the power consumption of sensors 612 and computing system 604 based on their operational status, using energy-efficient components or algorithms, and/or implementing power-saving modes. In some cases, the power management techniques may also involve monitoring the state of the battery, such as its charge level or its temperature, and adjusting the power consumption of the system accordingly.

In some aspects, additional safety features may be added to the system to enhance its reliability and safety. For example, a fail-safe mechanism may be implemented to ensure that the system continues to operate even in the event of a sensor failure. This fail-safe mechanism may involve using redundant sensors, switching to a backup system, or implementing a fault-tolerant algorithm. Similarly, a redundancy mechanism may be implemented to ensure that the system continues to operate even if one of the sensors fails. This redundancy mechanism may involve using multiple sensors of the same type, using different types of sensors that provide similar data, and/or using a voting or consensus algorithm to combine the data from multiple sensors.

In some cases, computing system 604 may use optical sensors 622 (e.g., cameras, lidar and/or radars) to detect known landmarks and refine the position estimates. Optical sensors 622 may be configured to capture images or radar data of the environment around railway vehicle 602, and this data may be processed to identify landmarks or other features. The identified landmarks may be compared with a database of known landmarks, and the location of the railway vehicle may be refined based on the location of the identified landmarks. This approach may be particularly useful in environments with distinctive landmarks, or when the GPS signal is weak or unavailable.

In some embodiments, computing system 604 may communicate with a predictive maintenance system to identify track sections that may require maintenance. The predictive maintenance system may use the precise location data along with vibration sensors to identify track sections that may be degrading or that may pose a risk of derailment. This integration could help prevent track degradation and potential derailments, improving overall safety and efficiency of the rail network.

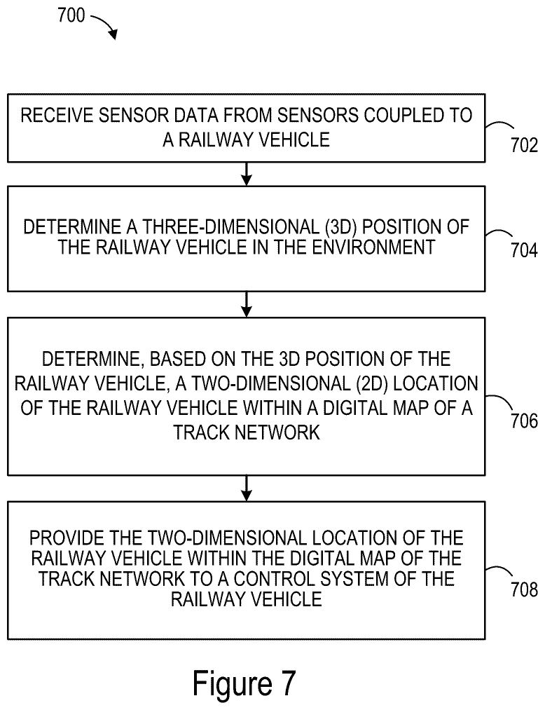

FIG. 7 is a flowchart of a method for performing multi-sensor fusion railway vehicle localization. Method 700 represents an example method that may include one or more operations, functions, or actions, as depicted by one or more of blocks 702, 704, 706, and 708, each of which may be carried out by any of the systems, devices, and/or vehicles shown in FIGS. 1-6, among other possible systems.

Those skilled in the art will understand that the flowcharts described herein illustrate functionality and operations of certain implementations of the present disclosure. In this regard, each block of the various flowcharts may represent a module, a segment, or a portion of program code, which includes one or more instructions executable by one or more processors for implementing specific logical functions or steps in the process. The program code may be stored on any type of computer readable medium, for example, such as a storage device including a disk or hard drive.

In addition, each block may represent circuitry that is wired to perform the specific logical functions in the process. Alternative implementations are included within the scope of the example implementations of the present application in which functions may be executed out of order from that shown or discussed, including substantially concurrent or in reverse order, depending on the functionality involved, as may be understood by those reasonably skilled in the art.

At block 702, method 700 involves receiving, at a computing system, sensor data from a plurality of sensors coupled to a railway vehicle as the railway vehicle travels along a rail in an environment. The sensors coupled to the railway vehicle may include a global positioning system (GPS) receiver, an inertial measurement unit (IMU), and an odometer. In some examples, the sensors may include one or more optical sensors. In some examples, the railway vehicle is a freight railway vehicle with the plurality of sensors retrofitted onto the freight railway vehicle using one or more mechanical connections.

In some examples, this step occurs while the railway vehicle is in motion, traveling along a rail track through its surrounding environment. The process of collecting and transmitting this data is continuous, providing a real-time stream of information about the vehicle's state and its surroundings. The plurality of sensors may include various types of data collection devices. These could encompass Global Positioning System (GPS) receivers to provide geographical location data, Inertial Measurement Units (IMUs) to measure acceleration, orientation, and angular velocity, and odometers to track the distance traveled by the railway vehicle. Additionally, the sensor array might include cameras to capture visual information about the surrounding environment, LiDAR (Light Detection and Ranging) sensors to create detailed 3D scans of the environment, radar systems to detect nearby objects or obstacles, and ultrasonic sensors for short-range distance measurements. These sensors continuously gather data about the railway vehicle's movement, position, and surroundings as it travels. The data from each sensor is transmitted to the computing system, which may be located on board the railway vehicle or in a remote location connected via a wireless network (such as remote computing system 624). This allows for real-time processing and analysis of the sensor data, enabling quick responses to changing conditions.

The environment through which the railway vehicle travels may include various features such as urban areas, rural landscapes, tunnels, bridges, elevated tracks, and different weather conditions. The sensors collect data that reflects these environmental factors, providing a comprehensive picture of the railway vehicle's journey. This environmental context is crucial for accurate positioning and navigation, as it allows the system to account for factors that might affect the vehicle's movement or sensor readings. By gathering diverse sensor data, the system can create a rich, multi-dimensional understanding of the railway vehicle's state and its relationship to its surroundings. This forms the foundation for accurate localization and navigation, enabling the system to make informed decisions about the vehicle's operation and route.

At block 704, method 700 involves determining, based on the sensor data, a three-dimensional position of the railway vehicle in the environment. In some cases, the computing system performs non-linear sensor fusion on the sensor data to determine the three-dimensional position of the railway vehicle in the environment. For instance, the computing system may use a Kalman filter, such as an extended Kalman filter (EKF) or an unscented Kalman filter (UKF), to perform the non-linear sensor fusion.

This process is crucial for accurately locating the vehicle in space, which is essential for navigation, safety, and operational efficiency. The computing system may perform nonlinear sensor fusion on the sensor data to determine the three-dimensional position. Sensor fusion combines data from multiple sensors to produce a more accurate and reliable position estimate than would be possible using any single sensor alone. Non-linear sensor fusion may be necessary because the relationships between sensor measurements and the vehicle's position are often non-linear, especially in complex railway environments.

In some instances, the computing system may use a Kalman filter, specifically advanced variants like the extended Kalman filter (EKF) or the unscented Kalman filter (UKF), to perform this nonlinear sensor fusion. These filters are recursive estimators that can handle non-linear systems and measurement models, making them well-suited for railway vehicle localization. The EKF and UKF allow the system to estimate the vehicle's position even when the relationship between sensor measurements and position is complex or when sensor data is noisy or incomplete. In practice, this sensor fusion might involve combining data from various sources. For example, GPS data might provide absolute position information, while an inertial measurement unit (IMU) offers data on the vehicle's acceleration and orientation. LiDAR sensors could provide detailed 3D scans of the surrounding environment, while cameras might recognize visual landmarks. Odometers could contribute data on the distance traveled. Each of these sensors has its strengths and limitations, and by fusing their data, the system can leverage the strengths of each while mitigating their individual weaknesses.

The Kalman filter works by predicting the vehicle's position based on its previous state and any known controls (like speed or steering commands), then updating this prediction based on the latest sensor measurements. This process is repeated continuously, allowing the system to maintain an up-to-date estimate of the vehicle's position even as it moves through varying environments and conditions. The non-linear nature of the EKF or UKF allows it to handle complex scenarios, such as when the vehicle is moving along curved tracks or when sensor readings are affected by factors like tunnels or nearby structures. By using these advanced non-linear sensor fusion techniques, the system can provide a robust and accurate three-dimensional position estimate of the railway vehicle, even in challenging and dynamic environments. This forms the foundation for subsequent navigation and control tasks, enabling safe and efficient operation of the railway vehicle.

At block 706, method 700 involves determining, based on the 3D position of the railway vehicle, a 2D location of the railway vehicle within a digital map of a track network. The track network includes the rail that the railway vehicle is traveling upon.

The computing system may relate the vehicle's precise spatial position to its location within the railway infrastructure. The track network includes the rail that the railway vehicle is traveling upon, as well as all other tracks, switches, stations, and relevant infrastructure in the system. In some examples, the digital map of the track network is a 2D representation of the railway system, as most railway operations and planning are conducted using 2D visualizations. The map may include detailed information about track geometry, including curves, gradients, and elevations, as well as the locations of signals, crossings, and other important features. The process of determining the 2D location involves projecting the 3D position onto this 2D map, taking into account the known layout and geometry of the track network.

In some cases, this determination may involve several steps. First, the system performs map matching, comparing the 3D position to the known locations of tracks in the digital map to identify the track segment that most closely matches the vehicle's position. Then, it conducts along-track localization, determining how far along that segment the vehicle is located, considering factors such as track curvature and elevation changes. The system may also calculate any cross-track error, estimating any deviation of the vehicle from the center of the track, which can be important for safety and maintenance purposes. In areas with complex infrastructure, such as multiple parallel tracks or intricate junctions, the system may need to use additional information to accurately determine the vehicle's location. This could include data such as the vehicle's heading or recent movement history. The resulting 2D location is typically expressed in terms of track identifiers and distances along those tracks, providing a precise description of the vehicle's position within the railway network.

The 2D location within the digital map may be used for many railway operations, including traffic management, scheduling, and safety systems. It allows the railway system to understand exactly where the vehicle is in relation to other trains, signals, stations, tunnels, bridges, and potential hazards. This information forms the basis for subsequent decision-making and control actions, ensuring safe and efficient operation of the railway vehicle within the larger network.

In some examples, a particle filter may be used, which can effectively use metadata of nodes, segments, and POIs to localize the railway vehicle in 2D and determine distances to POIs. In particular, the digital map information may convey metadata for nodes, such as geographical coordinates and node type, and metadata for segments like distance, speed limit, geographical coordinates, slope, and/or any other useful information. The process begins with initialization, where the filter generates a set of particles, each representing a possible 2D location of the railway vehicle on the digital map. These particles are initially distributed based on the projected 3D position and its uncertainty. As the vehicle moves, the filter enters the prediction phase, where it predicts the new position of each particle based on the vehicle's estimated motion and the known track geometry from the segment metadata. This step utilizes information such as track curvature, gradients, and connectivity between segments. Following prediction, the filter updates the weight of each particle based on how well it matches the observed sensor data and the metadata of nearby map features. This includes evaluating particles near nodes (e.g., switches, crossings) based on expected sensor readings at those locations, comparing observed track characteristics with the metadata of the segments where particles are located, and giving higher weights to particles near POIs if sensors detect corresponding features. The filter then performs resampling, where particles with higher weights are more likely to be retained and replicated, while low-weight particles are discarded. This process focuses the particle distribution around the most likely vehicle locations. After resampling, the vehicle's estimated 2D location is calculated as the weighted average of all particle positions.

Once the 2D location is estimated, the computing system can calculate the distance to any POI. This may involve identifying the current track segment, calculating the along-track distance to the POI using segment lengths and connectivity information, and adding any additional distance if the POI is not directly on the track. By continuously updating and refining the particle distribution using the rich metadata of the digital map, the particle filter can provide accurate 2D localization and reliable distance estimates to POIs, even in complex railway environments.

At block 708, method 700 involves providing the two-dimensional location of the railway vehicle within the digital map of the track network to a control system of the railway vehicle. In some examples, the computing system is coupled to the railway vehicle and controls the railway vehicle based on the two-dimensional location of the railway vehicle. For instance, the computing system may estimate a remaining travel time for the railway vehicle to reach a destination based on the two-dimensional location of the railway vehicle within the track network.

In some cases, the computing system may provide the two-dimensional location of the railway vehicle within the track network to a collision avoidance system. The collision avoidance system is configured to monitor travel operations of multiple railway vehicles. In some examples, the collision avoidance system is positioned remote from the railway vehicle, and the collision avoidance system is configured to monitor travel of a plurality of railway vehicles comprising the railway vehicle.

In some examples, method 700 further involves determining a distance to an upcoming track signal based on the two-dimensional location of the railway vehicle within the track network, wherein the predefined map of the track network specifies a location for a plurality of track signals.

In some examples, to determine the time of arrival at a POI, the computing system may use the 2D localization and distance calculation capabilities of the particle filter, incorporating additional data and calculations. The process begins with determining the current 2D location of the railway vehicle and calculating the distance to the POI using the particle filter method. This provides the base distance that needs to be traveled. The system then considers the current speed of the railway vehicle, which can be derived from recent position updates or directly from speedometer readings. It also takes into account the speed limits along the route to the POI, which are typically included in the segment metadata of the digital map. Additionally, the system analyzes the track characteristics between the current location and the POI. This includes factors such as track gradients, curves, weather conditions, and any known speed restrictions, all of which can affect travel time. For instance, uphill segments may require the train to slow down, while downhill segments might allow for faster travel.

In addition, any scheduled stops or potential delays along the route are also factored into the calculation. This could include stations where the train is scheduled to stop, or areas with known traffic congestion or maintenance work. Using all this information, the system calculates an estimated travel time to the POI. This might involve dividing the route into segments based on varying speed limits or track characteristics, calculating the time for each segment, and then summing these times. The estimated time of arrival is then determined by adding the calculated travel time to the current time. This estimate is continuously updated as the train progresses, taking into account any deviations from the expected speed or route. In more advanced systems, machine learning algorithms might be employed to refine these estimates over time, learning from historical data about actual travel times under various conditions. This could help account for factors that are harder to quantify, such as typical congestion patterns or seasonal variations in travel times.

The above detailed description describes various features and functions of the disclosed systems, devices, and methods with reference to the accompanying figures. While various aspects and embodiments have been disclosed herein, other aspects and embodiments will be apparent. The various aspects and embodiments disclosed herein are for purposes of illustration and are not intended to be limiting, with the true scope being indicated by the following claims.

It should be understood that arrangements described herein are for purposes of example only. As such, those skilled in the art will appreciate that other arrangements and other elements (e.g. machines, apparatuses, interfaces, functions, orders, and groupings of functions, etc.) can be used instead, and some elements may be omitted altogether according to the desired results. Further, many of the elements that are described are functional entities that may be implemented as discrete or distributed components or in conjunction with other components, in any suitable combination and location.

What is claimed is:

1. A method comprising:
receiving, at a computing system, sensor data from a plurality of sensors coupled to a railway vehicle as the railway vehicle travels along a rail in an environment;
determining, based on the sensor data, a three-dimensional (3D) position of the railway vehicle in the environment;
determining, by the computing system and based on the 3D position of the railway vehicle, a two-dimensional (2D) location of the railway vehicle within a digital map of a track network comprising the rail; and
providing the 2D location of the railway vehicle within the digital map of the track network to a control system of the railway vehicle.

2. The method of claim 1, wherein determining the three-dimensional position of the railway vehicle comprises:
performing non-linear sensor fusion on the sensor data to determine the three-dimensional position of the railway vehicle in the environment.

3. The method of claim 2, wherein performing nonlinear sensor fusion on the sensor data comprises using a Kalman filter, wherein the Kalman filter is an extended Kalman filter (EKF) or an unscented Kalman filter (UKF).

4. The method of claim 1, wherein determining the 2D location of the railway vehicle within the digital map of the track network comprises:
determining, using a particle filter, the 2D location of the railway vehicle within the digital map of the track network based on the 3D position of the railway vehicle in the environment.

5. The method of claim 1, wherein the plurality of sensors coupled to the railway vehicle comprises:
a global positioning system (GPS) receiver, an inertial measurement unit (IMU), and an odometer.

6. The method of claim 5, wherein the plurality of sensors further comprises:
one or more optical sensors.

7. The method of claim 1, further comprising:
determining a distance to an upcoming track signal based on the 2D location of the railway vehicle within the digital map of the track network, wherein the digital map of the track network specifies location information for a plurality of track signals.

8. The method of claim 1, further comprising:
providing the 2D location of the railway vehicle within the digital map of the track network to a collision avoidance system, wherein the collision avoidance system is configured to monitor travel of the railway vehicle.

9. The method of claim 8, wherein the collision avoidance system is positioned remote from the railway vehicle, and wherein the collision avoidance system is configured to monitor travel operations for a plurality of railway vehicles, wherein the plurality of railway vehicles includes the railway vehicle.

10. The method of claim 1, wherein the railway vehicle is a freight railway vehicle, and wherein the plurality of sensors are retrofitted onto the freight railway vehicle using one or more mechanical connections.

11. The method of claim 1, wherein the computing system is coupled to the railway vehicle, and wherein providing the 2D location of the railway vehicle within the digital map of the track network to the control system of the railway vehicle comprises:
controlling the railway vehicle based on the 2D location of the railway vehicle.

12. The method of claim 1, further comprising:
estimating a remaining travel time for the railway vehicle to reach a destination based on the 2D location of the railway vehicle within the digital map of the track network.

13. The method of claim 1, further comprising:
generating the digital map of the track network, wherein the digital map comprises a plurality of nodes and a plurality of segments, wherein each segment extends between at least a first node and a second node from the plurality of nodes.

14. The method of claim 13, wherein each segment comprises metadata specifying a speed limit, a latitude, a longitude, an elevation, and a segment identifier, and
wherein each node comprises metadata specifying a node type, a latitude, a longitude, an elevation.

15. The method of claim 14, further comprising:
assigning one or more points of interest (POI) at one or more locations within the digital map of the track network;
determining a distance between the 2D location of the railway vehicle and a first POI; and
wherein providing the 2D location of the railway vehicle within the digital map of the track network to the control system of the railway vehicle further comprises:
providing the distance between the 2D location of the railway vehicle and the first POI to the control system of the railway vehicle.

16. A system comprising:
a plurality of sensors coupled to a railway vehicle; and
a computing system configured to:
receive sensor data from a plurality of sensors coupled to a railway vehicle as the railway vehicle travels along a rail in an environment;
determine, based on the sensor data, a three-dimensional (3D) position of the railway vehicle in the environment;
determine, based on the 3D position of the railway vehicle, a two-dimensional (2D) location of the railway vehicle within a digital map of a track network comprising the rail; and
provide the 2D location of the railway vehicle within the digital map of the track network to a control system of the railway vehicle.

17. The system of claim 16, wherein the computing system is configured to:
perform nonlinear sensor fusion on the sensor data to determine the three-dimensional position of the railway vehicle in the environment.

18. The system of claim 16, wherein the railway vehicle is a freight railway vehicle, and wherein the plurality of sensors are retrofitted onto the freight railway vehicle using one or more mechanical connections.

19. The system of claim 18, wherein the freight railway vehicle further comprises a motor and a battery, wherein the motor is configured to provide torque to rotate at least one axle of the freight railway vehicle, and wherein the battery is configured to supply power to the motor.

20. A non-transitory computer readable medium configured to store instructions, that when executed by a computing system comprising one or more processors, causes the computing system to perform operations comprising:
receiving sensor data from a plurality of sensors coupled to a railway vehicle as the railway vehicle travels along a rail in an environment;
determining, based on the sensor data, a three-dimensional (3D) position of the railway vehicle in the environment;
determining, based on the 3D position of the railway vehicle, a two-dimensional (2D) location of the railway vehicle within a digital map of a track network comprising the rail; and
providing the 2D location of the railway vehicle within the digital map of the track network to a control system of the railway vehicle.
